(19) United States
(12) Patent Application Publication
(10) Pub. No.: US 2003/0137338 A1
(43) Pub. Date: Jul. 24, 2003

(54) Electronic apparatus

(76) Inventors: Toshiyuki Hisatsune, Tokyo (JP); Tsutomu Yamaguchi, Tokyo (JP); Hirokazu Okabe, Tokyo (JP); Yutaka Sato, Tokyo (JP)

Correspondence Address: Jay H Maioli, Cooper & Dunham, 1185 Avenue of The Americas, New York, NY, 10036, US

(21) Appl. No.: 10/204,867

(22) PCT Filed: Dec. 25, 2001
(86) PCT No.: PCT/JP01/11380

(30) Foreign Application Priority Data
Dec. 25, 2000 (JP) 2000-392876

(51) Int. Cl. G06G 7/18; G06G 7/19; G06F 7/64

(52) U.S. Cl. 327/337

(57) ABSTRACT

Electronic equipment comprises operation means 3, in which a plurality of key buttons 3a, 3a, . . . for inputting operations into the device by the user and a base member 3b connecting the plurality of key buttons 3a, 3a, . . . are formed integrally, containing a luminescent material, and panel means 1 placed above the operation means 3, formed from a member which can transmit light emitted by the operation means 3, in which a plurality of holes 1a, 1a, . . . are provided to enable operation of the plurality of key buttons 3a, 3a, . . . , in order to enable the user to judge the positions and functions of key buttons for operation even in darkness,.

### TECHNICAL FIELD

This invention relates to an electronic device suitable for being applied to remote control devices, portable telephones, radio receiver units, and the like.

### BACKGROUND ART

There have been proposed remote control devices for television receivers in which the key buttons have been designed to be luminescent, in order that the positions of the key buttons for operation can be judged even in darkness.

While a luminescent design for these key buttons has enabled the user to judge the positions of the key buttons, it has not been possible for the user to judge the functions of the key buttons.

### DISCLOSURE OF THE INVENTION

In light of this, an object of the present invention is to enable the user to judge the positions and functions of key buttons for operation, even in darkness.

In electronic equipment including a plurality of operation elements, an electronic device of this invention comprises: operation means, in which the plurality of operation elements are integrally formed with a base member which emits light through the release of stored optical energy; switching means, which puts a circuit of the electronic equipment into a closed state or an open state accompanied by depression of an operation element; and cover means, comprising holes corresponding to each of the operation elements for the purpose of depressing the operation elements, and which transmits at least part of the light emitted by the operation means.

According to this invention, since a plurality of operation elements and a base member which emits light through the release of stored optical energy are formed integrally, the entirety of this operation means emits light, the emitted light is transmitted through the transmissive cover means, and the transmission of light being through this cover means, thereby enables the user to judge the positions and functions of the operation elements for operation, even in darkness.

### BRIEF DESCRIPTION OF DRAWINGS

FIG. 1 is an exploded perspective view showing an embodiment of a remote control device according to the invention;

FIG. 2 is a top view of the embodiment in FIG. 1;

FIG. 3A is a partly enlarged perspective view showing an example of the rear face of an operation structure;

FIG. 3B is a partly enlarged top view showing an example of a connection contact;

FIG. 4 is a diagram used in explaining this invention;

FIG. 5 is a partly enlarged perspective view, used in explaining this invention; and,

FIG. 6 is a perspective view showing another embodiment of this invention.

### BEST MODE FOR CARRYING OUT THE INVENTION

Referring to the drawings, hereinafter, embodiments of the electronic device according to the present invention will be explained.

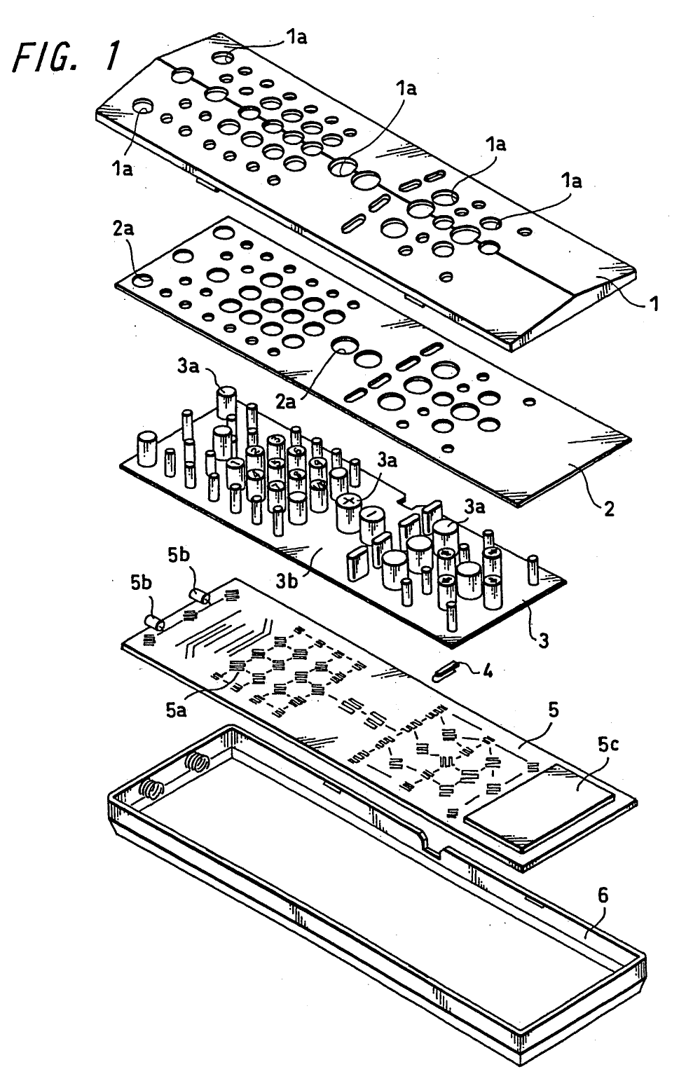

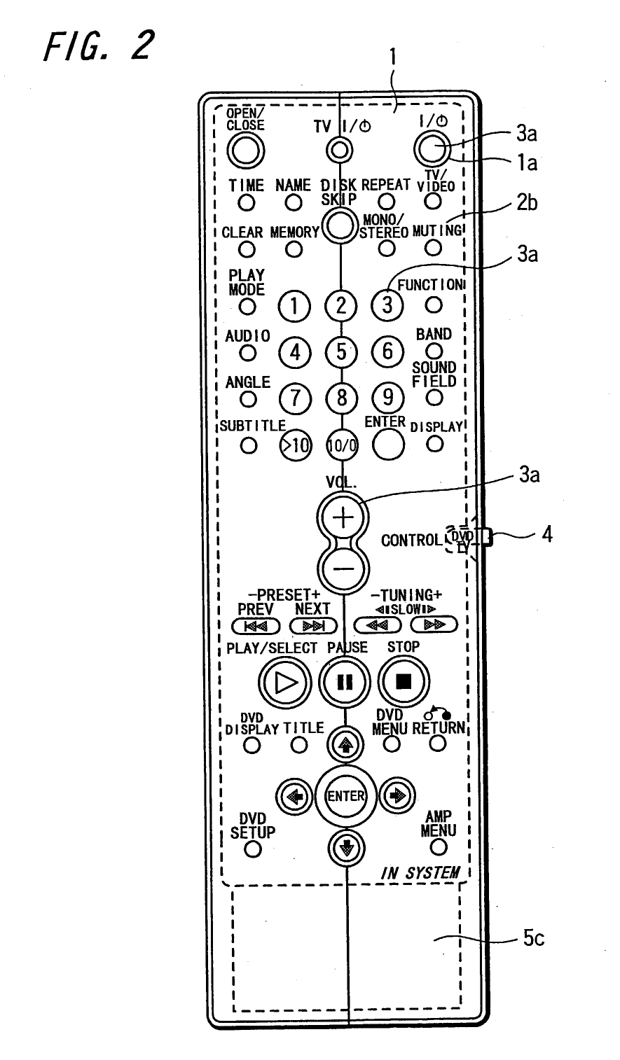

FIGS. 1 through 5 are diagrams showing an embodiment in which this invention is applied to a remote control device of a television receiver or the like. FIG. 2 is a top plan view seen from above the remote control device of this embodiment; as shown in FIG. 1, the remote control device of this embodiment comprises an upper panel 1, a semitransparent sheet 2, an operation structure 3 comprising a plurality of key buttons 3a, 3a, . . . and a base member 3b, a switching button 4, a circuit board 5, and a lower case 6.

As shown in FIGS. 1 and 2, this lower case 6 is a rectangular container formed of a synthetic resin, into which the rectangular semitransparent sheet 2, operation structure 3, and circuit substrate 5 are inserted. The upper panel 1 serves as a lid for the lower case 6 of a rectangular box, and is formed from, for example, transparent acrylic which transmits light; a plurality of holes 1a, 1a, . . . are formed in the upper panel 1, and through which the plurality of key buttons 3a, 3a, . . . are penetrated, so that the user can operate the plurality of key buttons 3a, 3a.

On a rectangular printed circuit board of this circuit board 5, circuit elements for remotely controlling a television receiver and DVD player, for example, and a plurality of connection contacts 5a, 5a, . . . , each short-circuited to the plurality of key buttons 3a, 3a, . . . , are mounted and further an infrared light-emitting diode 5b, photoelectric conversion element 5c for supplying power, and the like, are provided at predetermined positions. The switching button 4, which switches functions between that of a remote control device for a television receiver and that of a remote control device for a DVD player, is provided at a predetermined position.

The operation structure 3 comprises the plurality of key buttons 3a, 3a, . . . for inputting operations of a television receiver or DVD player by the user, and the connecting base member 3b formed integrally with this plurality of key buttons 3a, 3a, . . . , using silicon rubber, for example, in a manner similar to the prior art.

In this embodiment, the silicon rubber or other material forming this operation structure 3 is made to contain a luminescent material, such as, for example, “Picariko” (manufactured by Chemitech Inc.). In this case, the light emission color differs depending on the type of “Picariko” luminescent material; for example, the color is green for “Picariko CP-05”, blue for “Picariko CP-10”, purple for “Picariko CP-20”, and yellow for “Picariko CP-30”. It is possible, for example, to use luminescent materials with different light emission colors in the principal key buttons 3a, 3a, . . . of the operation structure 3.

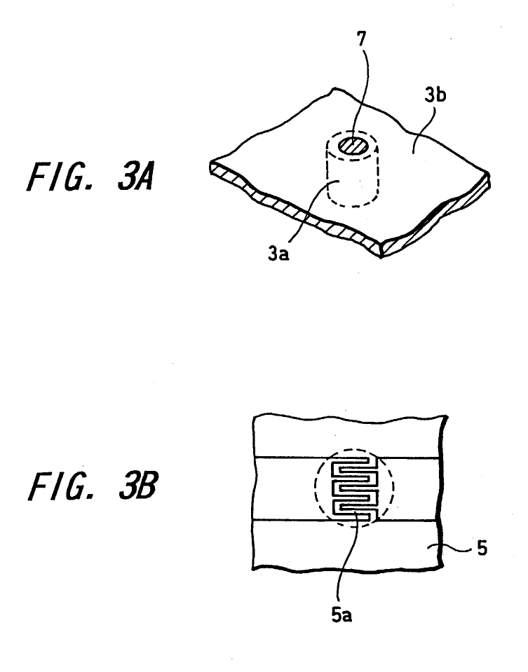

In this case, the key buttons 3a, 3a, . . . are formed in such a manner as to each protrude a predetermined height from the base member 3b on the front side of the operation structure 3, as shown in FIG. 1. As shown in FIG. 3A, carbon-impregnated portions 7, which are corresponding to the key buttons 3a, 3a, . . . , are provided on the rear side of the base member 3b, and by means of these carbon-impregnated portions 7, the connection contacts 5a, 5a, . . . on the circuit board 5 shown in FIG. 3B can be connected to be short-circuited as the key buttons 3a, 3a, . . . , are pressed downward.

The semitransparent sheet 2 formed with, for example, polycarbonate sheet which transmits light emitted from the base member 3b, is positioned between the base member 3b of the operation structure 3 and the upper panel 1, and is provided with holes 2a, 2a, . . . through which the plurality of key buttons 3a, 3a . . . penetrate. Further, in proximity to these holes 2a, 2a, . . . , displays 2b, for example, indication of the function related to the key buttons 3a, 3a, . . . which penetrate each hole 2a, 2a . . . are printed or otherwise displayed.

As shown in FIGS. 1 and 2, the remote control device according to this embodiment is configured such that the circuit board 5 is positioned within the lower case 6, together with the operation structure 3 in a predetermined position with respect to this circuit board 5, with the semitransparent sheet 2 above the operation structure 3 in a way that the key buttons 3a, 3a, . . . penetrate the holes 2a, 2a, . . . , with the upper panel 1 fixed in place with the key buttons 3a, 3a, . . . penetrating the holes 1a, 1a, . . . , acting as a lid for the lower case 6, and with the switching button 4 installed in a predetermined position.

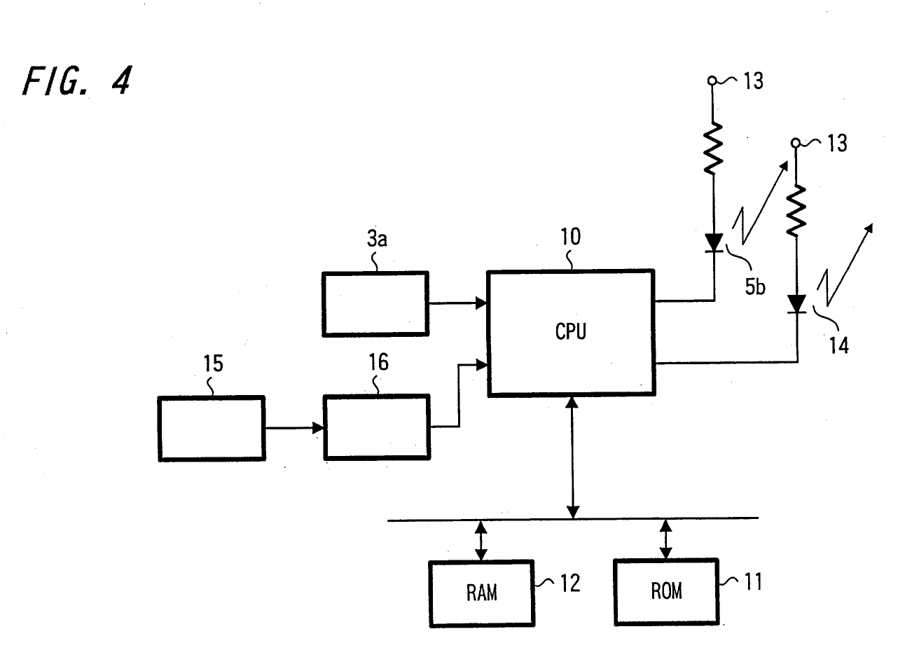

As shown in FIG. 4, in this remote control device, control signals are supplied to a microcomputer 10 according to the operation of the key buttons 3a, 3a, . . . by the user; in this microcomputer 10, remote control codes are read from a ROM 11 in which remote control codes corresponding to these control signals are stored in advance, the infrared light-emitting diode 5b is caused to emit light according to these remote control codes, and a television receiver, DVD player, or similar is operated remotely.

In FIG. 4, a working RAM 12 is connected to the microcomputer 10 via a bus line, while a predetermined program or similar is stored in the ROM 11, which is connected to the microcomputer 10 via the bus line. In FIG. 4, Numeral 13 denotes power supply terminals.

In this embodiment, as described above, the operation structure 3, in which a plurality of key buttons 3a, 3a, . . . and a rectangular base member 3b connecting this plurality of key buttons 3a, 3a, . . . are formed integrally, contains a luminescent material; hence the entirety of the operation structure 3 emits light, and this emitted light is transmitted through the semitransparent sheet 2 and upper panel 1, as well as the plurality of key buttons 3a, 3a, . . . emitting light. Therefore, even in darkness, the positions of the plurality of key buttons 3a, 3a, . . . , and the displays related to the key buttons 3a, 3a, . . . , that is, their functions, can be judged.

In this embodiment, displays, for example, printed functions or similar related to the key buttons 3a, 3a, . . . , are provided on the semitransparent sheet 2; hence the related displays are provided without difficulty, and in addition, when the remote control device is marketed in various countries around the world, it is only necessary to replace the semitransparent sheet 2 with another sheet having displays in the language of the country of use. Also, since the related displays are provided on the semitransparent sheet 2, the displays are not touched during use of the remote control device, so that the printing or similar is not peeled or otherwise removed by rubbing or similar.

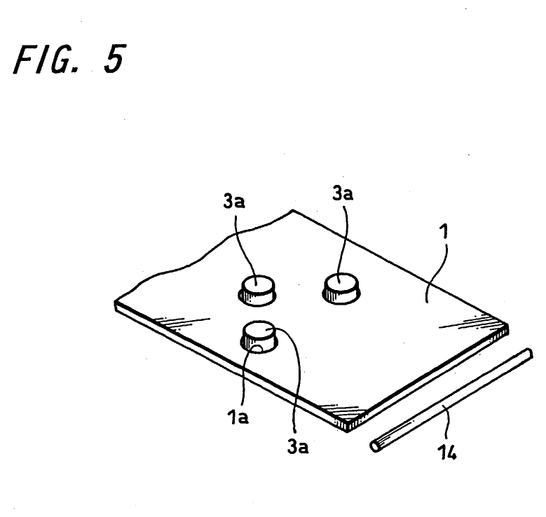

In this embodiment, in order to increase the light stored in the operation structure 3, a light-emitting diode 14 is provided in one side of the upper panel 1 as shown in FIGS. 4 and 5; whether the user is holding the remote control device is detected by means of a sensor 15, such as, for example, an electrostatic capacitance sensor, infrared sensor, or mechanical switch, and the light-emitting diode 14 is then caused to emit light for a predetermined length of time. When the light-emitting diode 14 emits light, light is stored in the luminescent material of the base member 3b and key buttons 3a, 3a, . . . of the operation structure 3.

Specifically, as shown in FIG. 4, the output signal of this sensor 15 is supplied to a detection circuit 16, and when this detection circuit 16 detects that the remote control device is being held by the user, the detected signal is supplied to the microcomputer 10, and the microcomputer 10 causes the light-emitting diode 14 to emit light for a predetermined length of time.

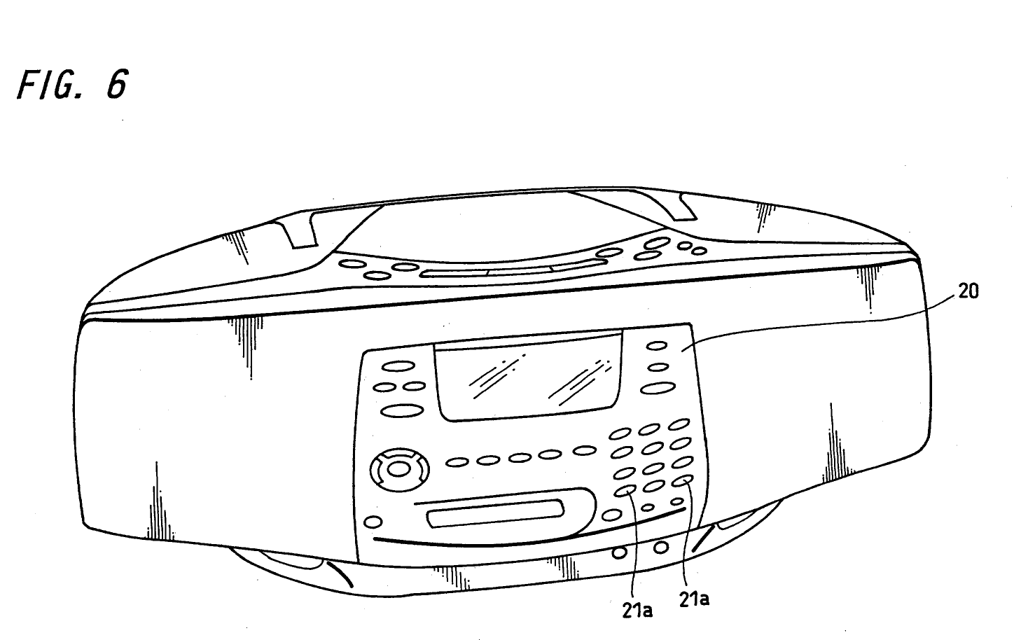

In the above-described embodiment, the case where this invention is applied to a remote control device is described; however as shown in FIG. 6, it is also possible to apply this invention to a radio receiver, portable telephone, or other electronic devices. In FIG. 6, a front panel 20 composed of an light transmission material, and an operation structure, in which a plurality of key buttons 21a, 21a, . . . as well as a base member connecting the plurality of key buttons 21a, 21a, . . . are formed integrally, contain luminescent material. Otherwise the configuration is similar to that of FIG. 1.

In the embodiment according to FIG. 6, it is understandable that an advantageous result similar to that of the embodiment shown in FIGS. 1 and 2 is also obtained.

In the above-described embodiments, the displays related to the key buttons 3a, 3a, . . . are provided on the semitransparent sheet 2; however, the displays related to the key buttons 3a, 3a, . . . (21a, 21a, . . . ) may be provided on the upper (front) panel 1 (20), on the side near the base member, without providing the semitransparent sheet 2. Such a configuration can also prevent the disappearance of the displays related to the key buttons 3a, 3a, . . . (21a, 21a, . . . ) due to rubbing or similar. Also, in this case the upper panel may be semitransparent rather than transparent, whereby a burr or the like originated in forming of the base member 3b is not easily seen, and fluctuation in brightness at different locations on the base member 3b are absorbed, so that light is transmitted in such a way that light emission is averaged.

The present invention is not limited to the above-described embodiments, and of course various other configurations may be adopted without deviating from the gist of this invention.

1. In electronic equipment including a plurality of operation elements, the electronic equipment comprises:
operation means, in which said plurality of operation elements are integrally formed with a base member which emits light through the release of stored optical energy;
switching means, which puts circuits of said electronic equipment into a closed state or an open state accompanied by depression of said operation elements; and
cover means, comprising holes corresponding to each of the operation elements for the purpose of depressing said operation elements, and transmitting at least part of the light emitted by said operation means.

2. The electronic equipment according to claim 1, wherein said cover means further comprises displays related to said operation elements.

3. The electronic equipment according to claim 2, wherein said displays are provided on the side, adjacent to said operation means, of said cover means.

4. The electronic equipment according to claim 1, further comprising:
light-transmitting display means provided between said cover means and said operation means, which transmits at least a part of the light emitted by said operation means, comprising: a plurality of holes corresponding to each of the operation elements for the purpose of depressing said operation elements; and a display related to said operation elements.

5. The electronic equipment according to claim 1, further comprising:
light emission means, provided adjacent to said operation means; and,
light emission control means, which controls the emission of light by said light emission means.

6. The electronic equipment according to claim 1, wherein said switching means causes at least two circuit patterns, provided on the circuit board, to be conducted in response to depression of said operation elements.
